(19) United States
(12) Patent Application Publication
(10) Pub. No.: US 2007/0159501 A1
(43) Pub. Date: Jul. 12, 2007

(54) A DATA DRIVER

(76) Inventors: Ying-Lieh Chen, Hsinhua (TW); Chin-Tien Chang, Hsinhua (TW)

Correspondence Address: LOWE HAUPTMAN BERNER, LLP, 1700 DIAGONAL ROAD, SUITE 300, ALEXANDRIA, VA, 22314, US

(21) Appl. No.: 11/279,670

(22) Filed: Apr. 13, 2006

(30) Foreign Application Priority Data
Jan. 6, 2006 (TW) 95100638

(51) Int. Cl. G09G 5/10

(52) U.S. Cl. 345/690

(57) ABSTRACT

A data driver has several gamma-voltage generating circuits and several driving channels. The gamma-voltage generating circuits are used to process gamma-voltages of different colors. Each two groups of the driving channels are correspondingly coupled with the gamma-voltage generating circuit that generates a single color and is separately disposed at either side of the corresponding gamma generating circuit for outputting the gamma-voltages of the same color to a display panel.

### RELATED APPLICATIONS

The present application is based on, and claims priority from, Taiwan Application Serial Number 95100638, filed Jan. 6, 2006, the disclosure of which is hereby incorporated by reference herein in its entirety.

### BACKGROUND

1. Field of Invention

The present invention relates to a data driver. More particularly, the present invention relates to a data driver used for a flat panel display.

2. Description of Related Art

With the rapid development in technology, flat panel displays (FPD) with their advantages of high image quality, compact size, light weight, low driving voltage and low power consumption have become very popular for incorporation into electrical devices and have become the mainstream display apparatus. For example, the FPD can be introduced into the portable TV, mobile phone, video recorder, computer monitor, and many other kinds of consumer electronics.

The FPD is driven by several source drivers (i.e. data drivers) that can transform the digital data (image data) into analog voltages for a display unit of the FPD. For example, the gamma curve relationship between the light passing through the display units and the analog voltages applied on the display units is nonlinear. Therefore, data drivers have gamma-voltage generating circuits to correct the analog voltages applied on the display unit. The gamma-voltage generating circuits can make the analog voltages applied on the display unit correspond to the variation of gamma curve when the digital data is transformed into analog voltages.

FIG. 1 is a functional block diagram depicting a traditional data driver. The traditional data driver 100 has several gamma-voltage generating circuits 130, 150 and 170, two driving channel sets 140 and 160, and a shift register 134. The shift register 134 is used to save an input data temporarily, and the driving channels in the driving channel sets 140 and 160 get the gamma-voltage generated by the gamma-voltage generating circuits according to the input data. The gamma-voltage generating circuits 130, 150 and 170 are arranged to generate several gamma-voltages of different colors individually; for example, the gamma-voltage generating circuit 130 is arranged to generate gamma-voltages of red color, the gamma-voltage generating circuit 150 is arranged to generate gamma-voltages of green color, and the gamma-voltage generating circuit 170 is arranged to generate gamma-voltages of blue color.

The driving channel sets 140 and 160 have several driving channels 131, 133, 151, 153, 171 and 173 to transmit gamma-voltages of different colors. Each driving channel has at least one digital-to-analog converter (not shown) connected to the gamma-voltage generating circuit and the shift register. The digital-to-analog converter gets the corresponding gamma-voltage generated by the gamma-voltage generating circuit according to the input data saved in the shift register 134 temporarily. One end of each driving channel is correspondingly connected to the gamma-voltage generating circuit of different colors individually; for example, the driving channels 131, 133 are correspondingly connected to the gamma-voltage generating circuit 130, the driving channels 151, 153 are correspondingly connected to the gamma-voltage generating circuit 150, and the driving channels 171, 173 are correspondingly connected to the gamma-voltage generating circuit 170. Furthermore, the other end of each driving channel is correspondingly connected to the data line of different colors of the display panel.

For example, the driving channels 131, 151 and 171 are correspondingly used for the data lines 191, 192 and 193 individually, and driving channels 133, 153 and 173 are correspondingly used for the data lines 194, 195 and 196 individually. The driving channel 131 is correspondingly connected to the gamma-voltage generating circuit 130 of red color (the connecting wire between the driving channel 131 and the gamma-voltage generating circuit 130 is not shown), and is correspondingly connected to the data line 191 of red color in the display panel 190. The driving channel 151 is correspondingly connected to the gamma-voltage generating circuit 150 of green color, and is correspondingly connected to the data line 192 of green color in the display panel 190. The driving channel 153 is correspondingly connected to the gamma-voltage generating circuit 170 of blue color, and is correspondingly connected to the data line 193 of blue color in the display panel 190. By the same way, the ends of driving channels 133, 153 and 173 are correspondingly connected to the gamma-voltage generating circuit 130 of red color, the gamma-voltage generating circuit 150 of green color and the gamma-voltage generating circuit 170 of blue color individually. The other ends of driving channels 133, 153 and 173 are correspondingly connected to the data line 194 of red color, the data line 195 of green color and the data line 196 of blue color in the display panel 190.

Typically, the gamma-voltage generating circuit is used to generate several gamma-voltages for the digital-to-analog converter of the driving channel described previously. The gamma-voltage generating circuit is composed of resistor chains, and the gamma-voltage can be obtained from the node between resistors. In the traditional circuit layout, the gamma-voltage generating circuit 130, 150 and 170 are neighbors and configured at the center of the data driver 100. The driving channel sets 140 and 160 are configured at the lateral sides of the centralized gamma-voltage generating circuits 130, 150 and 170. This kind of circuit layout needs sufficient space to transmit the gamma-voltages of different colors to the corresponding driving channels. For example, the driving channel 151 used to transmit the gamma-voltages of green color has to stride over the gamma-voltage generating circuit 130 for connecting to the corresponding gamma-voltage generating circuit 150. Therefore, the circuit layout of the gamma-voltage generating circuit 130 increases the length in the direction of arrow 101 to configure the connection between the driving channel 151 and the gamma-voltage generating circuit 150. By the same way, the driving channel 153 used to transmit the gamma-voltages for green color has to stride over the gamma-voltage generating circuits 170 for connecting to the corresponding gamma-voltage generating circuits 150. Therefore, the circuit layout of the gamma-voltage generating circuits 170 increases the length in the direction of arrow 101 to configure the connection between the driving channel 153 and the gamma-voltage generating circuit 150. Otherwise, the farther the distance between the gamma-voltage generating circuit and the driving channel (such as the driving channels 131 and 173 at the far end of the lateral sides), the easier the problems of voltages decay and time delay occur. Therefore, a data driver is needed with a new circuit layout to reduce the chip size and reduce the problems of voltage decay and time delay.

### SUMMARY

It is therefore an aspect of the present invention to provide a data driver with new circuit layout, which has smaller chip size, more stable voltage and more precise timing.

It is therefore another aspect of the present invention to provide a modulated data driver, of which each module has one gamma-voltage generating circuit and two driving channel sets to generate gamma-voltages of a single color.

According to one preferred embodiment of the present invention, the data driver comprises a plurality of gamma-voltage generating circuits and a plurality of driving channel sets. The gamma-voltage generating circuits are arranged to generate a plurality of gamma-voltages of different colors. Each two driving channel sets are connected to the corresponding gamma-voltage generating circuit of a single color for outputting the gamma-voltages of a the single color to the display panel, and each two driving channel sets are configured at two sides of the corresponding gamma-voltage generating circuit separately, wherein the neighboring gamma-voltage generating circuits that generate the gamma-voltages of different colors are separated by two connecting driving channel sets of different colors.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a functional block diagram depicting a traditional data driver.

FIG. 2 is a functional block diagram depicting one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

This invention offers a data driver with new circuit layout and uses several driving channel sets to separate the gamma-voltage generating circuits of different colors. Therefore, the chip size is decreased and the problems of voltages decay and time delay are reduced.

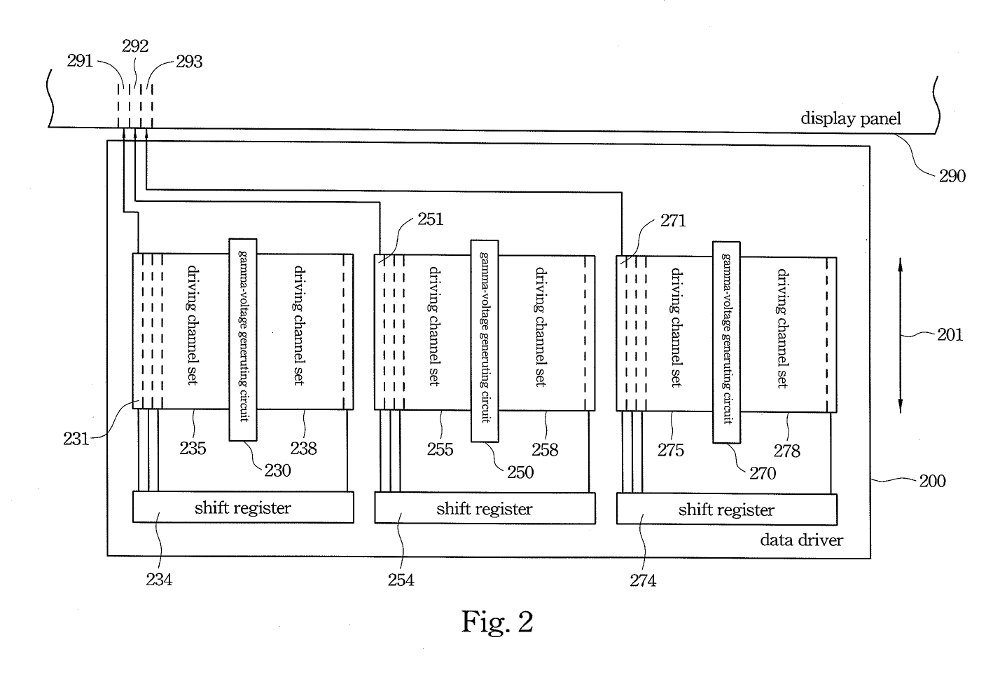

FIG. 2 is a functional block diagram depicting one preferred embodiment of the present invention. The data driver 200 of this preferred embodiment has a plurality of gamma-voltage generating circuits 230, 250, 270, and a plurality of driving channel sets 235, 238, 255, 258, 275, 278. The gamma-voltage generating circuits 230, 250 and 270 are arranged to generate a plurality of gamma-voltages of different colors. For example, the gamma-voltage generating circuit 230 is arranged to generate the gamma-voltages of red color, the gamma-voltage generating circuit 250 is arranged to generate the gamma-voltages of green color, and the gamma-voltage generating circuit 270 is arranged to generate the gamma-voltages of blue color.

Each two driving channel sets are connected to the corresponding gamma-voltage generating circuit of a single color for outputting the gamma-voltages of a the single color to the display panel 290, and each two driving channel sets are configured at two sides of the corresponding gamma-voltage generating circuit separately, wherein the neighboring gamma-voltage generating circuits that generate the gamma-voltages of different colors are separated by two connecting driving channel sets of different colors.

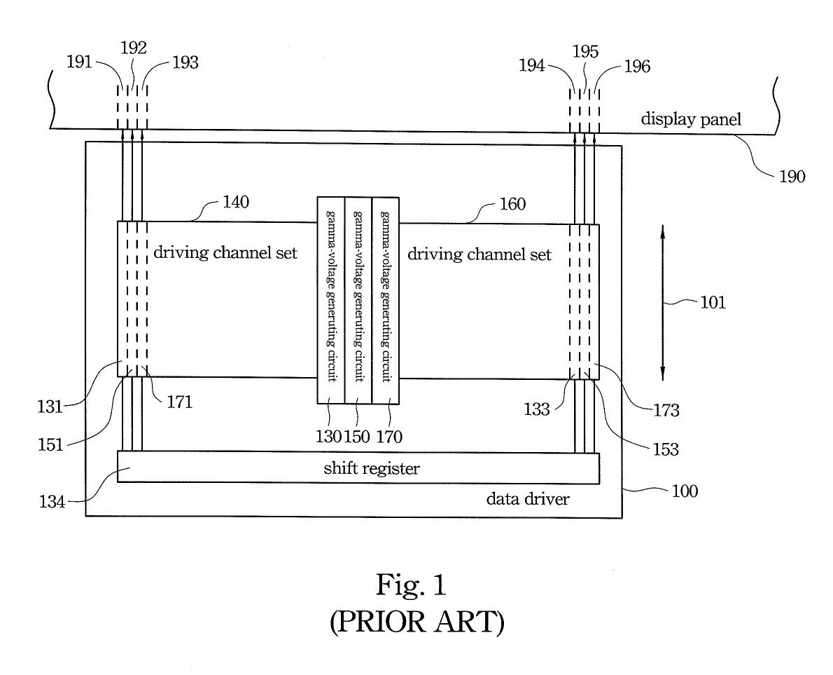

The driving channel set in this embodiment has several driving channels used to output the gamma-voltages of the single color. For example, the driving channels of driving channel sets 235 and 238 are all used to transmit the gamma-voltages of red color generated by the gamma-voltage generating circuit 230. The driving channels of driving channel sets 255 and 258 are all used to transmit the gamma-voltages of green color generated by the gamma-voltage generating circuit 250. The driving channels of driving channel sets 275 and 278 are all used to transmit the gamma-voltages of blue color generated by the gamma-voltage generating circuit 270. Each driving channel has at least one digital-to-analog converter (not shown) connected to the gamma-voltage generating circuit and the shift register. The digital-to-analog converter gets the corresponding gamma-voltage generated by the gamma-voltage generating circuit according to the input data saved in the shift register temporarily. In the traditional data driver 100 of FIG. 1, the driving channels used to transmit the gamma-voltages of different colors are configured in sequence. For example, the driving channels 131, 151 and 171 are used to transmit the gamma-voltages of red, green and blue colors in sequence. Therefore, the improvement of this preferred embodiment over the present invention is that each two driving channel sets used to transmit the gamma-voltages of same color are configured at two sides of the corresponding gamma-voltage generating circuit to form a module. The module is used to output the gamma-voltages with various gray-levels of the single color to shorten the conducting path and improve the problems of voltage decay and time delay. For example, compared with FIG. 1, the connection length between driving channel 231 and the gamma-voltage generating circuits 230 in FIG. 2 is only about one-third of the connection length between driving channel 131 and the gamma-voltage generating circuits 130 of the traditional data driver 100 in FIG. 1; and this configuration can reduce the problems of voltage decay and time delay.

The gamma-voltage generating circuits 230, 250 and 270 are used to generate the gamma-voltages for the digital-to-analog converters of the driving channel sets 235, 238, 255, 258, 275 and 278 described previously. The gamma-voltage generating circuits are usually designed as voltage dividers but are not limited thereby. For example, the gamma-voltage generating circuit is composed of resistor chains, and the gamma-voltage can be obtained from the nodes between resistors.

Furthermore, two driving channel sets used to transmit the gamma-voltages of the single color are configured symmetrically at and adjacent to the gamma-voltage generating circuit that is arranged to generate the gamma-voltages of the single color. For example, the driving channel sets 235 and 238 used to transmit the gamma-voltages of red color are configured symmetrically at and adjacent to the two sides of the gamma-voltage generating circuit 230, and the quantity of driving channels of driving channel sets 235 and 238 are about equal. Therefore, the power loadings of two sides of the gamma-voltage generating circuit are balanced, and the longest conducting path is shortened.

Otherwise, from FIG. 2, in the data driver 200 of this preferred embodiment, the neighboring gamma-voltage generating circuits that generate the gamma-voltages of different colors are separated by two connecting driving channel sets of different colors. For example, the gamma-voltage generating circuits 230 of red color and gamma-voltage generating circuits 250 of green color are separated by the driving channel sets 238 of red color and the driving channel sets 255 of green color.

Each driving channel set has a plurality of driving channels connected to data lines of the display panel separately. For example, in the display panel 290, the data line 291 is a red-color data line, the data line 292 is a green-color data line, and the data line 293 is a blue-color data line. The driving channel 231 of red color connects to the data line 291, the driving channel 251 of green color connects to the data line 292, and the driving channel 271 of blue color connects to the data line 293.

The data driver 200 of this preferred embodiment can be applied to the display panel that has to correct the analog voltages of display colors, such as in liquid crystal display panels, plasma display panels, organic light-emitting diode display panels and low temperature polysilicon thin film transistor display panels. Otherwise, the data driver of this preferred embodiment is used to correct three fundamental colors (red, green and blue) of a display panel. Even if the display colors of the display panel are not only three fundamental colors (such as red, green, blue and yellow), the data driver of this preferred embodiment can still be applied.

The data driver 200 of this preferred embodiment further comprises a plurality of sets of shift registers 234, 254 and 274 connected to the driving channels, wherein the shift registers are arranged to save an input data temporally, and the driving channels get the gamma-voltages generated by the gamma-voltage generating circuits according to the input data. For example, the shift register 234 connects to the driving channel sets 235 and 238, and the driving channels get the gamma-voltages generated by the gamma-voltage generating circuit 230 according to the input data.

In the circuit layout of this preferred embodiment, the different color connections between the driving channels and the corresponding gamma-voltage generating circuits are independent. Therefore, space for configuring the connection between the driving channels and the corresponding gamma-voltage generating circuits does not need to be reserved. Compared with FIG. 1, the length along the direction of arrow 201 is only about one-third of the length along the direction of arrow 101 in FIG. 1. This configuration can make the chip size smaller and decrease the cost of this chip so as to improve productivity.

The data driver of this embodiment is modular and the designer can design one kind of circuit layout for a gamma-voltage generating circuit by one gamma curve of one color. This kind of circuit layout can be duplicated for other colors. Therefore, this kind of circuit layout can save the time of design and wire routing and is convenient and flexible for testing and design change.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flat panel display has a display panel and a data driver, the data driver has a plurality of gamma-voltage generating circuits and a plurality of driving channel sets, and the gamma-voltage generating circuits are respectively arranged to generate a plurality of gamma-voltages of different colors, characterized in that:
each two driving channel sets are connected to and separately configured at two sides of the gamma-voltage generating circuit of a single color for outputting the gamma-voltages of the single color to the display panel, wherein the neighboring gamma-voltage generating circuits that generate the gamma-voltages of different colors are separated by two connecting driving channel sets of different colors.

2. The flat panel display as claimed in claim 1, wherein the each two driving channel sets are configured symmetrically at and adjacent to the gamma-voltage generating circuit that is arranged to generate the gamma-voltages of the single color.

3. The flat panel display as claimed in claim 1, wherein each driving channel set has a plurality of driving channels connected to data lines of the display panel separately.

4. The flat panel display as claimed in claim 1, wherein the display panel is a liquid crystal display panel, a plasma display panel, an organic light-emitting diode display panel or a low temperature polysilicon thin film transistor display panel.

5. The flat panel display as claimed in claim 1, wherein the color is red, green or blue.

6. The flat panel display as claimed in claim 1, further comprising a plurality of sets of shift registers connected to the driving channels, wherein the shift registers are arranged to save an input data temporarily, and the driving channels get the gamma-voltages generated by the gamma-voltage generating circuits according to the input data.

7. A data driver comprises:
a plurality of gamma-voltage generating circuits arranged to generate a plurality of gamma-voltages of different colors; and
a plurality of driving channel sets, wherein each two driving channel sets are connected and separately configured at two sides of the gamma-voltage generating circuit of a single color for outputting the gamma-voltages of the single color to the display panel, wherein the neighboring gamma-voltage generating circuits that generate the gamma-voltages of different colors are separated by two connecting driving channel sets of different colors.

8. The data driver as claimed in claim 7, wherein the each two driving channel sets are configured symmetrically at and adjacent to the gamma-voltage generating circuit that is arranged to generate the gamma-voltages of the single color.

9. The data driver as claimed in claim 7, wherein each driving channel set has a plurality of driving channels connected to data lines of the display panel separately.

10. The data driver as claimed in claim 7, wherein the display panel is a liquid crystal display panel, a plasma display panel, an organic light-emitting diode display panel or a low temperature polysilicon thin film transistor display panel.

11. The data driver as claimed in claim 7, wherein the color is red, green or blue.

12. The data driver as claimed in claim 7, further comprising a plurality of sets of shift registers connected to the driving channels, wherein the shift registers are arranged to save an input data temporarily, and the driving channels get the gamma-voltages generated by the gamma-voltage generating circuits according to the input data.
